(19) United States
(12) Patent Application Publication
(10) Pub. No.: US 2021/0065101 A1
(43) Pub. Date: Mar. 4, 2021

(54) INFORMATION PROCESSING APPARATUS, INFORMATION PROCESSING SYSTEM, AND NON-TRANSITORY COMPUTER READABLE MEDIUM

(71) Applicant: FUJI XEROX CO., LTD., Tokyo (JP)

(72) Inventor: Hironobu NAGAYAMA, Kanagawa (JP)

(73) Assignee: FUJI XEROX CO., LTD., Tokyo (JP)

(21) Appl. No.: 16/748,989

(22) Filed: Jan. 22, 2020

(30) Foreign Application Priority Data
Aug. 28, 2019 (JP) 2019-155355

(51) Int. Cl. G06Q 10/08; G06N 5/04; G06Q 10/10; G06K 15/00

(52) U.S. Cl. CPC G06Q 10/087; G06N 5/04; G06Q 10/0838; G06K 15/4075; G06Q 10/109

(57) ABSTRACT

An information processing apparatus includes: a transmission unit that transmits remaining amount information indicating a detected remaining amount of a consumable; a reception unit that receives a scheduled date of delivery of the consumable notified based on the transmitted remaining amount information; and a request unit that, when the remaining amount of the consumable is detected again upon reception of the scheduled delivery date and when a first value corresponding to the remaining amount detected again differs from a second value predicted, in correspondence with the first value, from information on a history of consuming the consumable, makes a request to change the scheduled delivery date in such a way that the second value approaches or matches the first value.

### CROSS-REFERENCE TO RELATED APPLICATIONS

This application is based on and claims priority under 35 USC 119 from Japanese Patent Application No. 2019-155355 filed Aug. 28, 2019.

### BACKGROUND

### (i) Technical Field

The present disclosure relates to an information processing apparatus, an information processing system, and a non-transitory computer readable medium.

### (ii) Related Art

In recent years, there has been proposed a consumable management device that can appropriately provide a consumable delivery instruction to an installation location of an image forming apparatus (for example, see JP-A-2014-91298).

The consumable management device disclosed in JP-A-2014-91298 includes an acquisition unit that acquires a value indicating a consumption degree of a consumable from an image forming apparatus, a prediction unit that predicts a value indicating a consumption degree of the consumable when the consumable needs to be replaced based on a changing trend of the value indicating the consumption degree of the consumable acquired by the acquisition unit, and an instruction unit that issues an instruction to deliver the consumable to the installation location of the image forming apparatus based on a result predicted by the prediction unit.

Even if the scheduled date of delivery of the consumable is determined in consideration of the changing trend of the remaining amount until the notification date of the remaining amount of the consumable, the delivery date varies depending on the use status of the consumable between the notification date of the remaining amount of the consumable and the scheduled delivery date.

### SUMMARY

Aspects of non-limiting embodiments of the present disclosure relate to providing an information processing apparatus, an information processing system, and a non-transitory computer readable medium, which count predicted consumption of a consumable during a period from the date of notification of the remaining amount of the consumable to the scheduled date of delivery of the consumable so that the delivery date schedule can be optimized as compared to a case where such predicted consumption is not counted.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing apparatus including: a transmission unit that transmits remaining amount information indicating a detected remaining amount of a consumable; a reception unit that receives a scheduled date of delivery of the consumable notified based on the transmitted remaining amount information; and a request unit that, when the remaining amount of the consumable is detected again upon reception of the scheduled delivery date and when a first value corresponding to the remaining amount detected again differs from a second value predicted, in correspondence with the first value, from information on a history of consuming the consumable, makes a request to change the scheduled delivery date in such a way that the second value approaches or matches the first value.

### BRIEF DESCRIPTION OF THE DRAWINGS

Exemplary embodiments of the present invention will be described in detail based on the following figures, wherein:

FIG. 1 is a configuration diagram showing a schematic configuration example of a consumable delivery system according to an exemplary embodiment of the present disclosure;

FIG. 2 is a block diagram showing an example of a control system of an image forming apparatus;

FIG. 3 is a diagram showing an example of print history information;

FIG. 4 is a block diagram showing an example of a control system of a delivery management apparatus;

FIG. 5 is a diagram showing an example of device information;

FIG. 6 is a diagram showing an example of consumable information;

FIG. 7 is a diagram showing an example of a menu screen;

FIG. 8 is a flowchart showing an example of the operation of the image forming apparatus;

FIG. 9 is a flowchart showing an example of the operation of the delivery management apparatus;

FIG. 10 is a diagram showing Example 1 of a business calendar; and

FIG. 11 is a diagram showing Example 2 of the business calendar.

### DETAILED DESCRIPTION

Hereinafter, an exemplary embodiment of the present disclosure will be described with reference to the drawings. In each figure, components having substantially the same function are denoted by the same reference numerals, and redundant description thereof is omitted. Hereinafter, although a consumable delivery system will be described as an example of an information processing system, the information processing system is not limited to the consumable delivery system. Further, although an image forming apparatus will be described as an example of an information processing apparatus, the information processing apparatus is not limited to the image forming apparatus.

### SUMMARY OF EXEMPLARY EMBODIMENTS

The exemplary embodiment is directed to an information processing apparatus including: a transmission unit that transmits remaining amount information indicating a detected remaining amount of a consumable; a reception unit that receives a scheduled date of delivery of the consumable notified based on the transmitted remaining amount information; and a request unit that, when the remaining amount of the consumable is detected again upon notification of the scheduled delivery date and when a first value corresponding to the remaining amount detected again differs from a second value predicted, in correspondence with the first value, from information on the history of consuming the consumable, makes a request to change the scheduled delivery date in such a way that the second value approaches or matches the first value.

The combinations of the first value and the second value include the following.

(a) The remaining amount of a consumable (first value) and the maximum amount of possible consumption of the consumable by the scheduled delivery date (second value)

(b) The number of prints possible with the remaining amount of the consumable (first value) and the maximum number of prints possible by the scheduled delivery date (second value)

(c) The scheduled delivery date (first value) and the desired delivery date (second value)

### EXEMPLARY EMBODIMENT

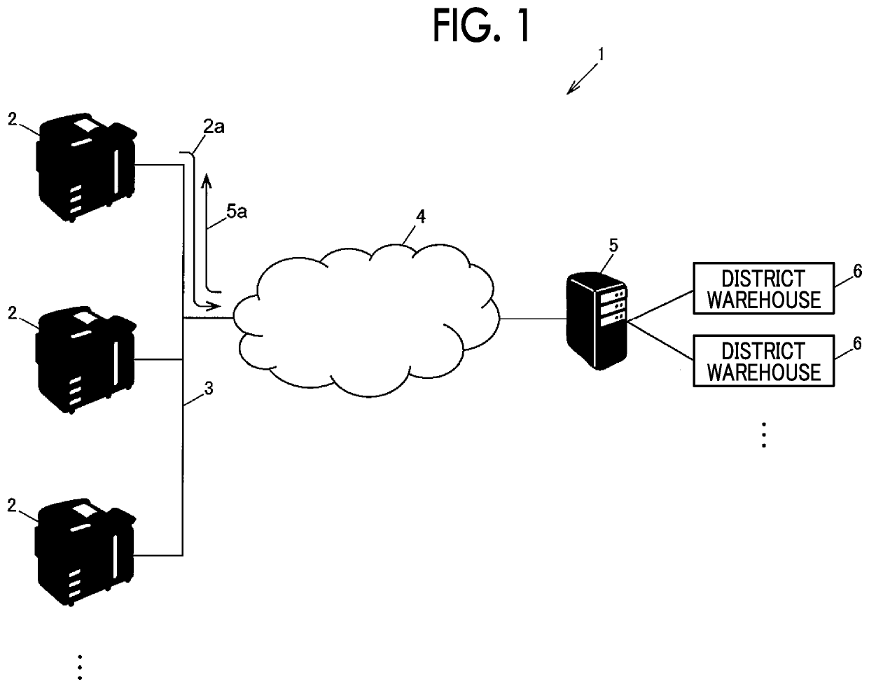

FIG. 1 is a configuration diagram showing a schematic configuration example of a consumable delivery system 1 according to an exemplary embodiment of the present disclosure. The consumable delivery system 1 includes plural image forming apparatuses (hereinafter, also referred to as a device) 2 connected to a delivery management apparatus 5 via an internal network 3 and an external network 4. The delivery management apparatus 5 is connected to plural district warehouses 6. The consumable delivery system 1 is an example of an information processing system. The image forming apparatus 2 is an example of an information processing apparatus.

The image forming apparatus 2 is a multifunction apparatus having plural functions such as a scan function, a printer function, a copy function, a facsimile function, and an e-mail function. The image forming apparatus 2 may be an image forming apparatus having a single function such as a printer or a facsimile.

The internal network 3 is a communication network such as a local area network (LAN) or a wide area network (WAN). The external network 4 is a communication network such as the Internet.

The district warehouse 6 stores a consumable and delivers the consumable to the installation location of the apparatus 5 based on delivery date information 5a transmitted from the delivery management apparatus 5. As will be described later, the delivery date information 5a includes a scheduled delivery date, a consumable type, and a device ID.

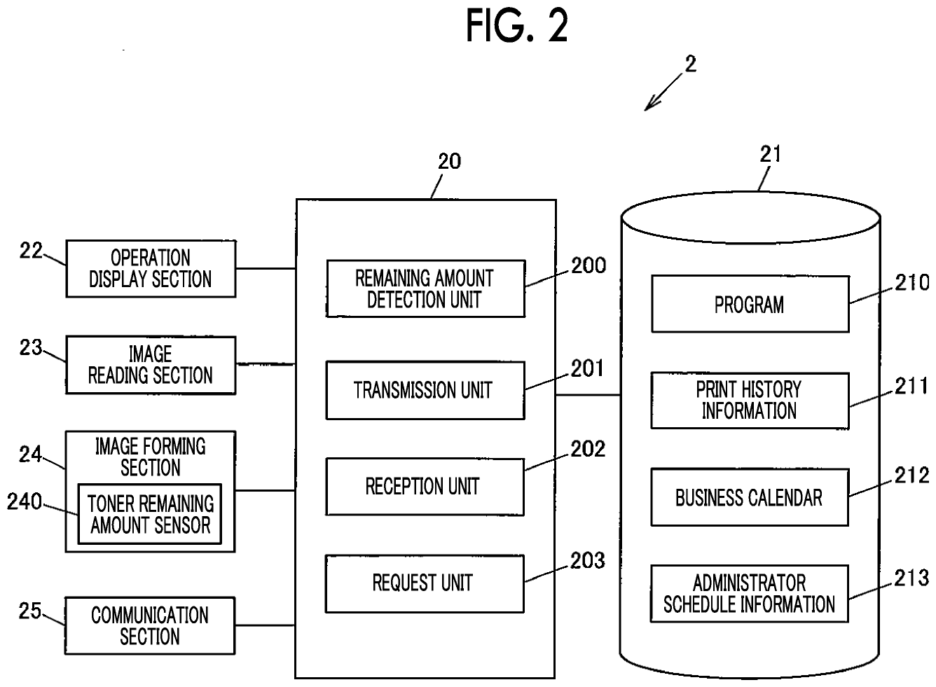

FIG. 2 is a block diagram showing an example of a control system of the image forming apparatus 2. The image forming apparatus 2 includes a control section 20 that controls each section of the apparatus 2, a storage section 21 that stores various types of data, an operation display section 22 that inputs and displays information, an image reading section 23 that reads a document image from an original document, an image forming section 24 that prints out the image, and a communication section 25 that communicates with the delivery management apparatus 5 via the internal network 3 and the external network 4.

The control section 20 includes a central processing unit (CPU), an interface, and the like. The CPU functions as a remaining amount detection unit 200, a transmission unit 201, a reception unit 202, a request unit 203, and the like by executing a program 210 stored in the storage section 21. Details of each of the units 200 to 203 will be described later.

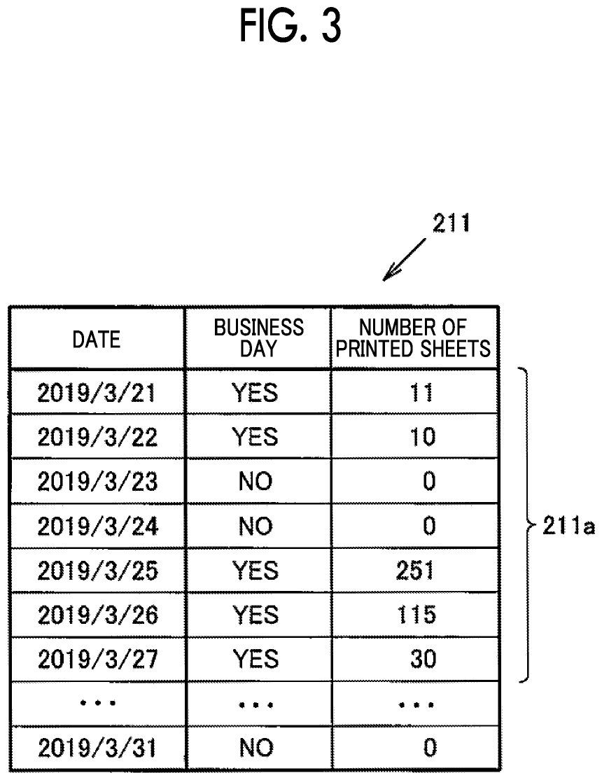

The storage section 21 includes a read only memory (ROM), a random access memory (RAM), a hard disk, and the like, and stores various data such as the program 210, print history information 211 (see FIG. 3), a business calendar 212, and administrator schedule information 213. The print history information 211 is stored in the storage section 21 by the control section 20 for the past one year, for example. The print history information 211 is an example of information on the history of consuming a consumable.

The business calendar 212 is a calendar showing the business days of the office or business office where the device 2 is installed. The administrator schedule information 213 is information indicating the scheduled attendance date or the scheduled absence date of the administrator of the device 2. The business calendar 212 and the administrator schedule information 213 may be stored in an external server and acquired by the request unit 203 accessing the external server as necessary.

The operation display section 22 is, for example, a touch panel display, and has a configuration in which a touch panel is superposed on a display such as a liquid crystal display.

The image reading section 23 reads a document image from an original document, includes an automatic document feeder (not shown) provided on a document table (not shown) and a scanner (not shown), and optically reads a document image from an original document placed on the document table or an original document sent by the automatic document feeder.

The image forming section 24 prints out a color image or a black and white image on a recording medium such as paper by, for example, an electrophotographic method. The image forming section 24 includes a toner remaining amount sensor 240. The toner remaining amount sensor 240 is provided for each of toner bottles corresponding to colors of Y (yellow), M (magenta), C (cyan), and K (black), and transmits a detection signal indicating a voltage corresponding to the toner remaining amount in the toner bottle to the remaining amount detection unit 200. The image forming section 24 may be dedicated for monochrome printing. A toner bottle is an example of the consumable. The remaining amount of toner is an example of the remaining amount of the consumable.

The communication section 25 is realized by a network interface card (NIC) or the like, and transmits and receives information to and from the delivery management apparatus 5 via the internal network 3 and the external network 4.

FIG. 3 is a diagram showing an example of the print history information 211. The print history information 211 includes items such as “date”, “business day”, and “number of printed sheets”. In the print history information 211, a value corresponding to each item is recorded by the control section 20 every time execution of a print job is completed. In the “date”, the date of print job execution is recorded. In the “business day”, YES is recorded when the day when the print job is executed corresponds to a business day, and NO is recorded when the day corresponds to a closed day with reference to the business calendar 212 showing the business day. In the “number of printed sheets”, the number of sheets printed in black and white is recorded. Print history information including a record of the amount of toner used for each of black and white printing and color printing or for each color printing may be used instead of the print history information 211 in FIG. 3. Further, the print history information 211 may be transmitted to the delivery management apparatus 5 by the transmission unit 201 periodically (for example, at the end of business, at the end of the month, and the like).

Next, each of the units 200 to 203 of the control section 20 will be described.

The remaining amount detection unit 200 detects the remaining amount of toner according to the detection signal output from the toner remaining amount sensor 240. When the detected toner remaining amount becomes equal to or less than a predetermined toner remaining amount (for example, 90% of the full state), the remaining amount detection unit 200 generates consumable remaining amount information 2a including the toner remaining amount according to the detection signal output from the toner remaining amount sensor 240, the consumable type indicating the type of toner (black toner, yellow toner, and the like), and the device ID for identifying the own apparatus 2. Regardless of the ratio of the remaining amount of toner, the consumable remaining amount information 2a may be generated periodically (for example, every day, at the end of the month, and the like), and the consumable remaining amount information 2a may be transmitted to the delivery management apparatus 5 by the transmission unit 201.

The transmission unit 201 transmits the consumable remaining amount information 2a generated by the remaining amount detection unit 200 to the delivery management apparatus 5 by the communication section 25 via the internal network 3 and the external network 4.

The reception unit 202 receives the delivery date information 5a including scheduled delivery date from the delivery management apparatus 5.

When the scheduled delivery date is notified from the delivery management apparatus 5, the request unit 203 acquires the toner remaining amount from the remaining amount detection unit 200 again, acquires print history information 211a for the most recent given time period (for example, one week) from the print history information 211 stored in the storage section 21, and calculates the remaining number of possible prints Na from the remaining amount of toner acquired again using, for example, the following equation (1).

Na=Tr2/Tp (1)

Tr2: toner remaining amount acquired again
Tp: average toner use amount per sheet

Na is an example of the first value and the remaining amount of consumable.

The request unit 203 calculates the first predicted number of prints Ne1 from the print history information 211a using, for example, the following equation (2).

Ne1=Nmax×(N+1) (2)

Nmax: the maximum number of printed sheets per day in the print history information 211a for the most recent one week (in addition, other time periods such as the most recent one month and the most recent one year may be used).

N: number of days from the date the scheduled delivery date is received to the scheduled delivery date (the received date is not counted)

When the first predicted number of prints Ne1 is not larger than the remaining number of possible prints Na (Ne1≤Na), the request unit 203 notifies the delivery management apparatus 5 of a delivery delay instruction so that the scheduled delivery date is changed to the next day. When the first predicted number of prints Ne1 is larger than the remaining number of possible prints Na (Na1>Na), for example, the request unit 203 calculates the second predicted number of prints Ne2 using the following equation (3).

Ne2=Nmax×N (3)

Ne1 and Ne2 are examples of the second value and are examples of the maximum amount of possible consumption of the consumable by the scheduled delivery date.

The request unit 203 displays the scheduled delivery date on the operation display section 22 when the second predicted number of prints Ne2 is not larger than the remaining number of possible prints Na (Ne2≤Na). When the second predicted number of prints Ne2 is larger than the remaining number of possible prints Na (Ne2>Na), the request unit 203 notifies the delivery management apparatus 5 to deliver today, changes the scheduled delivery date to today, and displays the changed scheduled delivery date on, for example, a menu screen 220 of the operation display section 22.

Configuration of Delivery Management Apparatus

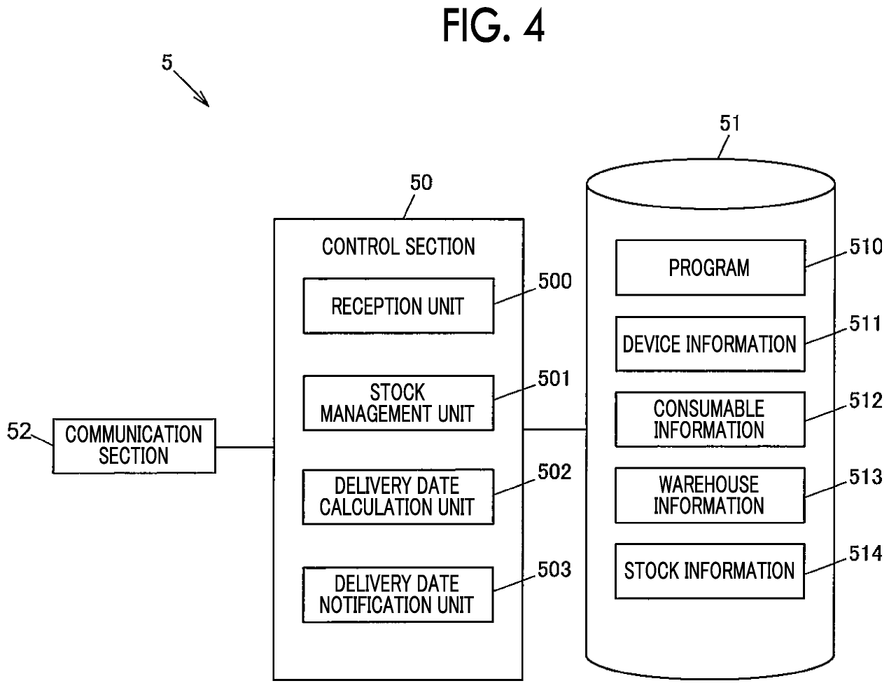

FIG. 4 is a block diagram showing an example of a control system of the delivery management apparatus 5. The delivery management apparatus 5 includes a control section 50 that controls each section of the apparatus 5, a storage section 51 that stores various data, and a communication section 52 that communicates with the image forming apparatus 2 via the external network 4 and the internal network 3.

The control section 50 includes a central processing unit (CPU), an interface, and the like. The CPU functions as a reception unit 500, a stock management unit 501, a delivery date calculation unit 502, a delivery date notification unit 503, and the like by executing a program 510 stored in the storage section 51. Details of each of the units 500 to 503 will be described later.

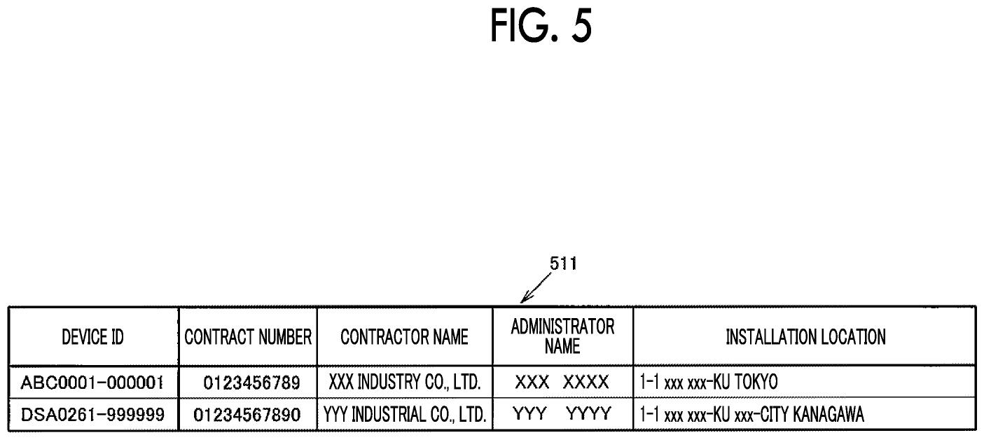

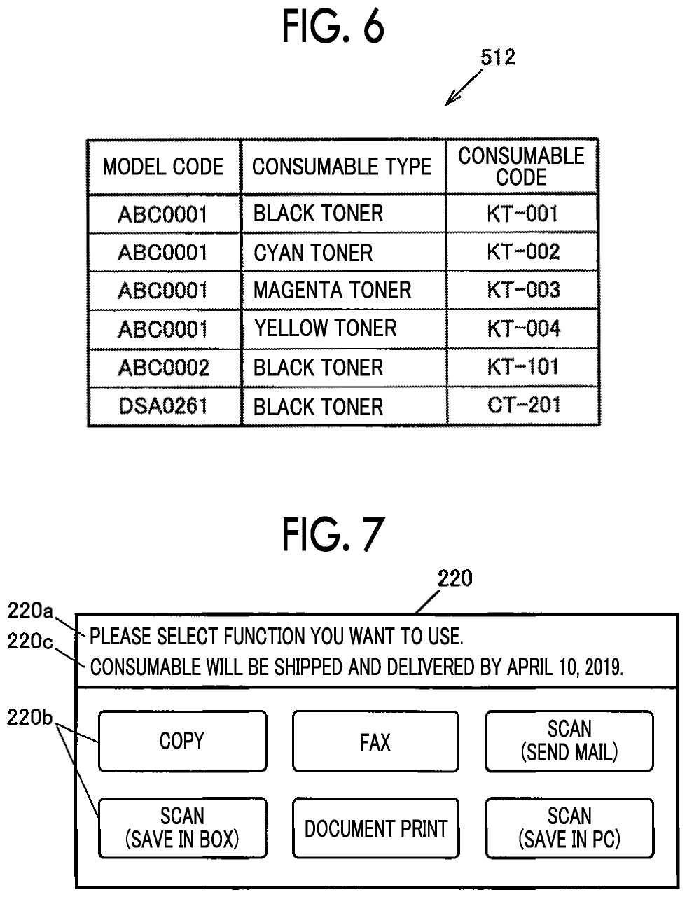

The storage section 51 includes a read only memory (ROM), a random access memory (RAM), a hard disk, and the like, and stores various data such as the program 510, device information 511 (see FIG. 5), consumable information 512 (see FIG. 6), warehouse information 513, and stock information 514.

The warehouse information 513 includes information on the position of the district warehouse 6 that stores consumables until they are delivered to the device 2. That is, the warehouse information 513 includes the warehouse number and an address as an example of information on the position of the district warehouse 6 close to the device 2 corresponding to the device ID.

The stock information 514 includes consumable stock information indicating how many consumables are stored in which district warehouse 6. That is, the stock information 514 includes, for each warehouse number of the district warehouse 6, a consumable type, a consumable code, the number of stored consumables, and the like.

FIG. 5 is a diagram showing an example of the device information 511. The device information 511 includes items such as “device ID”, “contract number”, “contractor name”, “administrator name”, and “installation location”. In the “device ID”, a device ID for identifying the device 2 is recorded. The device ID has a model code at the front and a serial number at the back. In the “contract number”, a contract number for specifying the content of a contract between the person who uses the device 2 and the person who provides the delivery service is recorded. In the “contractor name”, the name of the person who uses the device 2 is recorded. In the “administrator name”, the name of the person who manages the device 2 is recorded. In the “installation location”, the address where the device 2 is installed is recorded.

FIG. 6 is a diagram showing an example of the consumable information 512. The consumable information 512 includes items such as “model code”, “consumable type”, and “consumable code”. In the “model code”, the model code of the device 2 is recorded. In the “consumable type”, any of black toner, cyan toner, magenta toner, and yellow toner is recorded as the type of consumable. In the “consumable code”, a consumable code for specifying a consumable is recorded.

Next, each of the units 500 to 503 of the control section 50 will be described.

The reception unit 500 receives the consumable remaining amount information 2a and a delivery delay instruction notification from the device 2.

The stock management unit 501 determines whether or not there is stock in the district warehouse 6 with reference to the consumable information 512, the warehouse information 513, and the stock information 514 corresponding to the device 2 that transmitted the consumable remaining amount information 2a. In particular, the stock management unit 501 specifies the warehouse number of the district warehouse 6 close to the device 2 with reference to the warehouse information 513 based on the device ID included in the consumable remaining amount information 2a. Next, the stock management unit 501 acquires the consumable type from the consumable remaining amount information 2a and determines whether or not there is stock in the district warehouse 6 with reference to the stock information 514 based on the warehouse number and the consumable type. If there is no stock in the district warehouse 6, the stock management unit 501 instructs delivery of the consumable to the district warehouse 6.

The delivery date calculation unit 502 calculates the scheduled delivery date based on the consumable remaining amount information 2a transmitted from the device 2. At this time, the delivery date calculation unit 502 calculates the scheduled delivery date including the grace period so that the request to change the scheduled delivery date from the device 2 will be a request to delay the scheduled delivery date. That is, the delivery date calculation unit 502 calculates the number of days M from the toner remaining amount Tr1 included in the consumable remaining amount information 2a using, for example, the following equation (4).

M=(Tr1/Tp)/Nmax+Ms (4)

Tr1: toner remaining amount

Tp: average toner use amount per sheet

Nmax: the maximum number of printed sheets per day in the print history information 211a for the most recent one week

Ms: number of spare days (for example, two business days)

When a print job is notified from the device 2 every day at a predetermined time (for example, at the end of business), and the storage section 51 holds print history information similar to the print history information 211 held by the device 2, the delivery date calculation unit 502 acquires the print history information 211a for the most recent one week from its own storage section 51. If the storage section 51 does not store such print history information, the device 2 may be requested to send the print history information 211a for the most recent one week.

The delivery date calculation unit 502 calculates the scheduled delivery date by adding the number of days M to the date when the consumable remaining amount information 2a is received (excluding holidays and consider business days only). The delivery date calculation unit 502 may calculate the scheduled delivery date without considering the business day if the device 2 makes a request to change the scheduled delivery date in consideration of the business day.

The delivery date notification unit 503 notifies of the scheduled delivery date by transmitting the delivery date information 5a including the scheduled delivery date calculated by the delivery date calculation unit 502, the consumable type, and the device ID to the device 2 by the previous day. When there is a delivery delay instruction from the device 2, the delivery date notification unit 503 waits for one day and determines the scheduled delivery date. When there is no delivery delay instruction from the device 2, the delivery date notification unit 503 transmits the delivery date information 5a to the district warehouse 6 after receiving a response from the device 2.

Operation of Consumable Delivery System

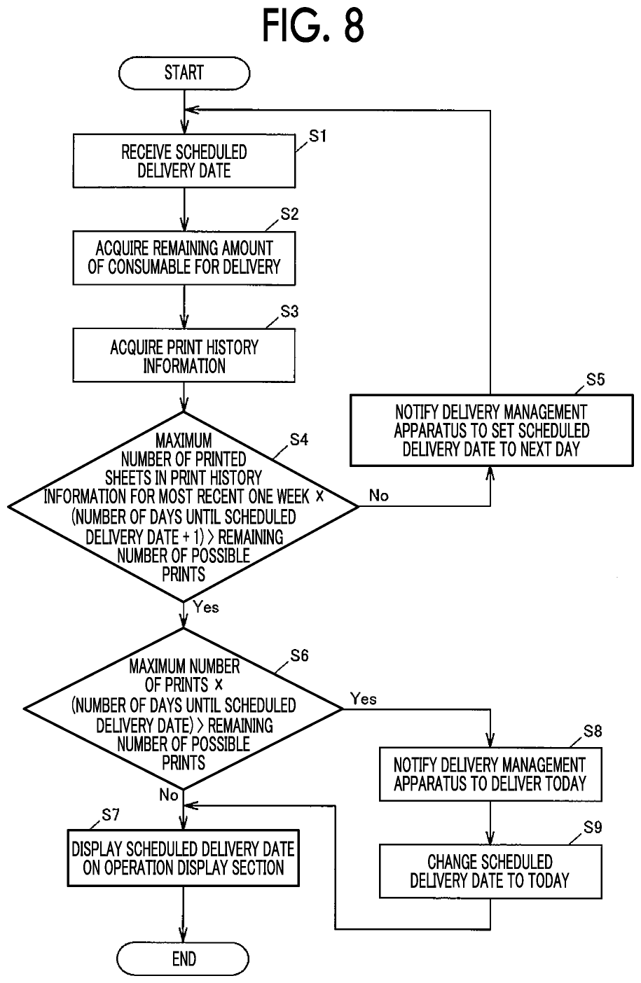

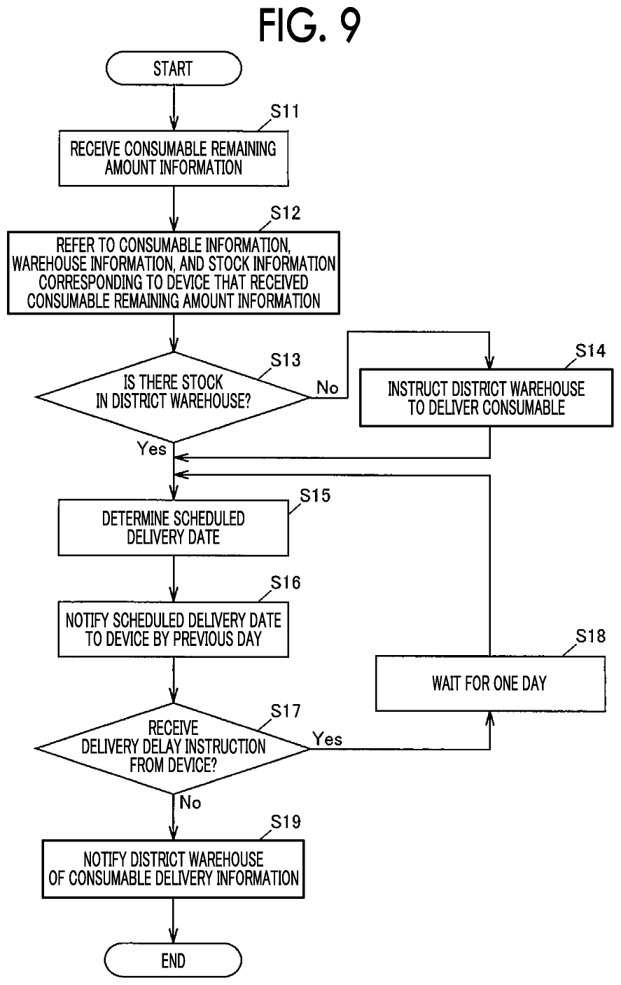

Next, an example of the operation of the consumable delivery system 1 will be described with reference to FIGS. 7 to 9. FIG. 8 is a flowchart showing an example of the operation of the device 2. FIG. 9 is a flowchart showing an example of the operation of the delivery management apparatus 5.

(1) Operation of Device

The remaining amount detection unit 200 of the device 2 detects the toner remaining amount by the toner remaining amount sensor 240 and generates the consumable remaining amount information 2a including the toner remaining amount, the consumable type, and the device ID. The transmission unit 201 transmits the consumable remaining amount information 2a to the delivery management apparatus 5. The delivery management apparatus 5 that received the consumable remaining amount information 2a calculates the scheduled delivery date for delivering the consumable based on the toner remaining amount as will be described later.

The reception unit 202 receives the delivery date information 5a including the scheduled delivery date, the consumable type, and the device ID from the delivery management apparatus 5 (S1).

The request unit 203 acquires the toner remaining amount from the remaining amount detection unit 200 again (S2) and acquires the print history information 211a for the most recent given time period (for example, one week) from the print history information 211 stored in the storage section 21 (S3).

Next, the request unit 203 calculates the remaining number of possible prints Na from the toner remaining amount acquired again using the equation (1) and calculates the first predicted number of prints Ne1 from the print history information 211a using the equation (2).

Subsequently, the request unit 203 determines whether or not the first predicted number of prints Ne1 is larger than the remaining number of possible prints Na (Ne1>Na) (S4), and when the first predicted number of prints Ne1 is not larger than the remaining number of possible prints Na (Ne1≤Na) (S4: No), the request unit 203 notifies the delivery management apparatus 5 to set the scheduled delivery date to the next day as a delivery delay instruction (S5).

When the first predicted number of prints Ne1 is larger than the remaining number of possible prints Na (Na1>Na) (S4: Yes), the request unit 203 calculates the second predicted number of prints Ne2 using the equation (3).

The request unit 203 determines whether or not the second predicted number of prints Ne2 is larger than the remaining number of possible prints Na (Ne2>Na) (S6), and when the second predicted number of prints Ne2 is not larger than the remaining number of possible prints Na (Ne2≤Na) (S6: No), the request unit 203 displays the scheduled delivery date on the operation display section 22 (S7).

FIG. 7 is a diagram showing an example of a menu screen of the operation display section 22 on which the scheduled delivery date is displayed. The menu screen 220 displays a message 220a “Please select the function you want to use”, various buttons 220b for instructing execution of functions, and a message 220c “Consumable will be shipped and delivered by Apr. 10, 2019”, which includes a scheduled delivery date. The screen for displaying the scheduled delivery date is not limited to the menu screen 220, and may be another screen, such as a setting screen for each function, or the currently displayed screen.

When the second predicted number of prints Ne2 is larger than the remaining number of possible prints Na (Ne2>Na) (S6: Yes), the request unit 203 notifies the delivery management apparatus 5 to deliver today (S8).

The request unit 203 changes the scheduled delivery date to today (S9) and displays the changed scheduled delivery date on the menu screen 220 of the operation display section 22, for example (S7).

(2) Operation of Delivery Management Apparatus

The reception unit 500 of the delivery management apparatus 5 receives the consumable remaining amount information 2a from the device 2 (S11).

The stock management unit 501 refers to the consumable information 512, the warehouse information 513, and the stock information 514 corresponding to the device 2 that transmitted the consumable remaining amount information 2a (S12) and determines whether or not there is stock in the district warehouse 6 (S13). In particular, the stock management unit 501 specifies the warehouse number of the district warehouse 6 close to the device 2 with reference to the warehouse information 513 based on the device ID included in the consumable remaining amount information 2a. Next, the stock management unit 501 acquires the consumable type from the consumable remaining amount information 2a and determines whether or not the consumable is in stock in the district warehouse 6 with reference to the stock information 514 based on the warehouse number and the consumable type.

When there is no stock in the district warehouse 6 (S13: No), the stock management unit 501 instructs delivery of the consumable to the district warehouse 6 (S14).

When there is stock in the district warehouse 6 (S13: Yes), the delivery date calculation unit 502 calculates and determines the scheduled delivery date (S15). That is, the delivery date calculation unit 502 calculates the number of days M from the toner remaining amount Tr1 included in the consumable remaining amount information 2a using the equation (4).

The delivery date calculation unit 502 calculates the scheduled delivery date by adding the number of days M to the date when the consumable remaining amount information 2a is received (excluding holidays and consider business days only).

The delivery date notification unit 503 notifies of the scheduled delivery date by transmitting the delivery date information 5a including the scheduled delivery date, the consumable type, and the device ID to the device 2 by the previous day (S16).

The delivery date notification unit 503 determines whether or not there is a delivery delay instruction from the device 2 (S17), and when there is a delivery delay instruction (S17: Yes), waits for one day (S18) and determines the scheduled delivery date (S15).

When there is no delivery delay instruction from the device 2 (S17: No), the delivery date notification unit 503 transmits the delivery date information 5a to the district warehouse 6 after receiving a response from the device 2 (S19). The district warehouse 6 prepares to deliver the corresponding consumable on the scheduled delivery date based on the delivery date information 5a. When there is no change notification until the scheduled delivery date, the consumable is delivered to the installation location of the device 2 on the scheduled delivery date.

### Example 1

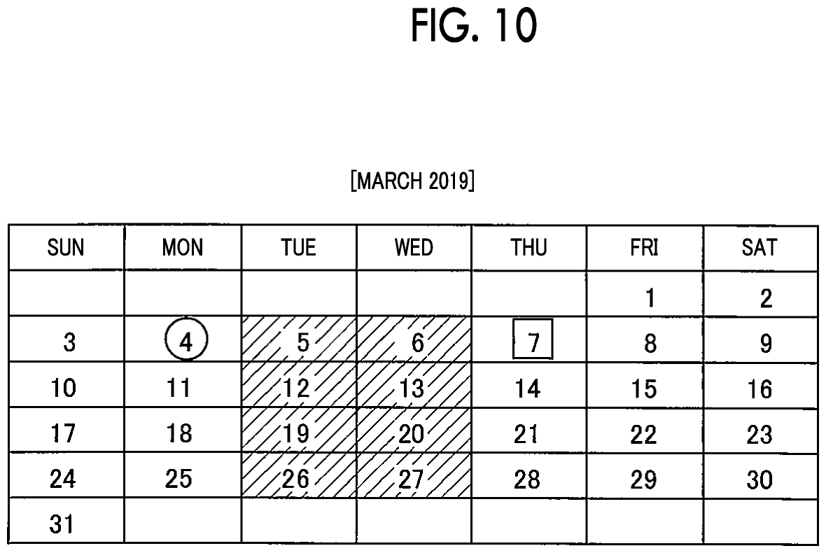

FIG. 10 is a diagram showing Example 1 of a business calendar 212. In FIG. 10, it is assumed that hatched Tuesdays and Wednesdays are office holidays and other days are business days. A circle indicates a date when a notification of a scheduled delivery date is received, and a square indicates a scheduled delivery date.

When the device 2 receives “black toner delivery date information 5a with a scheduled delivery date of March 7” on March 4, if it is determined that March 5 and March 6 are office holidays and the most recent printing status indicates that no replacement is required as of March 8, a delivery delay instruction is notified to the delivery management apparatus 5. The delivery management apparatus 5 may determine the next scheduled delivery date in consideration of the notification content from the device 2 and working day or holiday of the district warehouse 6. In this case, when the next scheduled delivery date is notified, the working day or holiday of the delivery side is also notified. Even when the device 2 once determines that the notification of the next scheduled delivery date is unnecessary, if the device 2 finds out that delivery by the district warehouse 6 is impossible on the next day, the device 2 omits the notification of the delivery delay instruction.

### Example 2

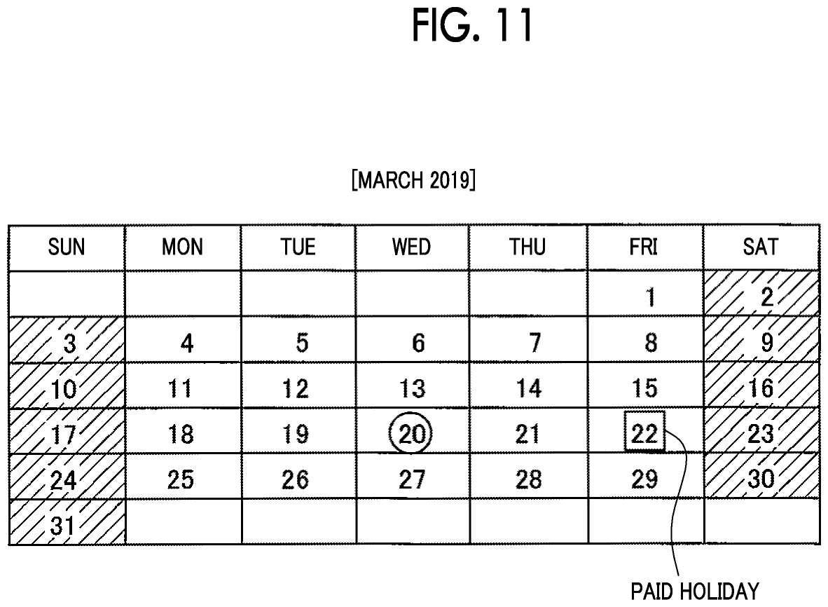

FIG. 11 is a diagram showing Example 2 of the business calendar 212. In FIG. 11, it is assumed that hatched Saturdays and Sundays are office holidays and other days are business days. It is assumed that 22nd is a holiday (paid) for the administrator. A circle indicates a date when a notification of a scheduled delivery date is received, and a square indicates a scheduled delivery date.

When the device 2 receives “cyan toner delivery date information 5a with a scheduled delivery date of March 22” on March 20, since it is known that the administrator is absent on March 22 from the administrator schedule information 213, a delivery delay instruction is notified to the delivery management apparatus 5. In this case, a request is made to deliver on March 25, the first business day after March 22.

Although the exemplary embodiments of the present disclosure have been described, the exemplary embodiments of the present disclosure are not limited to the above-described exemplary embodiment, and various modifications and implementations are possible without departing from the scope of the present disclosure.

### Modification Example 1

The number of sheets is compared in step S4 of the flowchart of FIG. 8, but the amount of toner may be compared. In this case, the maximum toner use amount per day×the number of days until the scheduled delivery date (or the number of days obtained by adding one day to this) is calculated as the second value. Further, the toner amount for each color may be compared. In offices that carry out color printing more than black and white printing, it is possible to optimize the delivery date of the color toner bottle as compared with the case where the toner use prediction between the notification date of the toner remaining amount and the scheduled date of delivery of the toner bottle is not considered.

### Modification Example 2

Although the first predicted number of prints Ne1 or the second predicted number of prints Ne2 is compared with the remaining number of possible prints Na in steps S4 and S6 of the flowchart of FIG. 8, the desired delivery date may be calculated and the desired delivery date may be compared with the scheduled delivery date. In this case, for example, the number of days Ma is calculated by dividing the toner remaining amount Tr2 by the maximum number of printed sheets Nmax, and the desired delivery date is calculated by adding the number of days Ma and the number of spare days (for example, one day) Ms to today. In step S4 of the flowchart of FIG. 8, when the first predicted print number Ne1 is not larger than the remaining number of possible prints Na, a delivery delay instruction is issued so that the scheduled delivery date is the next day. However, the delivery management apparatus 5 may be requested to calculate the desired delivery date and set the desired delivery date as the scheduled delivery date.

### Modification Example 3

In steps S4 and S6 of the flowchart of FIG. 8, the print history information 211a for the most recent one week is referred to. Alternatively, the accounting month of a company may be set in the device 2, and when today is in the accounting month, the print history information on the same month in the previous year may also be referred to, and it may be determined whether or not to delay the scheduled delivery date by using the larger number of printed sheets.

### Modification Example 4

In steps S4 and S6 of the flowchart of FIG. 8, the print history information for the most recent one week, the corresponding quarter of the previous year, the most recent one month, and the most recent one year may be used, and the maximum number of printed sheets of these may be adopted. Not only the most recent period before the day but also a nearby time period including before and after the day may be referred to. That is, when it is possible to grasp the period during which the toner use amount is greatly influenced in advance, the print history information for that time period may be referred to.

### Modification Example 5

In the above-described exemplary embodiment, the delivery management apparatus 5 calculates so that the scheduled delivery date does not precede the desired delivery date, and notifies of the delivery delay instruction when the device 2 makes a request to change the scheduled delivery date. However, for example, the scheduled delivery date may be calculated from the average number of printed sheets, and the device 2 may notify the delivery delay instruction according to the number of printed sheets or may request that the delivery be advanced.

Part or whole of each unit of the control section 20 may include a hardware circuit such as a reconfigurable circuit (FPGA: Field Programmable Gate Array) or an application specific integrated circuit (ASIC).

It is possible to omit or change some of the constituent elements of the above-described exemplary embodiments without departing from the scope of the present disclosure. In the flows of the above-described exemplary embodiments, steps may be added, deleted, changed, or replaced without departing from the scope of the present disclosure. The programs used in the exemplary embodiments described above may be provided by being recorded in computer readable recording media such as CD-ROMs. Alternatively, the programs used in the exemplary embodiments described above may be stored in an external server such as a cloud server and used via a network.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a transmission unit that transmits remaining amount information indicating a detected remaining amount of a consumable;
a reception unit that receives a scheduled date of delivery of the consumable notified based on the transmitted remaining amount information; and
a request unit that, when the remaining amount of the consumable is detected again upon reception of the scheduled delivery date and when a first value corresponding to the remaining amount detected again differs from a second value predicted, in correspondence with the first value, from information on a history of consuming the consumable, makes a request to change the scheduled delivery date in such a way that the second value approaches or matches the first value.

2. The information processing apparatus according to claim 1, wherein
when the first value differs from the second value, the request unit makes a request to shift the scheduled delivery date by a predetermined number of days once or a plurality of times.

3. The information processing apparatus according to claim 1, wherein
the scheduled delivery date is determined so that the request is to delay the scheduled delivery date by a period including a grace period.

4. The information processing apparatus according to claim 1, wherein
the first value is a remaining amount of the consumable, and
the second value is a maximum amount of possible consumption of the consumable by the scheduled delivery date.

5. The information processing apparatus according to claim 4, wherein
the first value is the number of prints possible with the remaining amount of the consumable, and
the second value is the maximum number of prints possible by the scheduled delivery date.

6. The information processing apparatus according to claim 5, wherein
at least one time when the amount of possible consumption of the consumable will reach or exceed a threshold determined based on the consuming history information is counted in determining the number of sheets as the second value.

7. The information processing apparatus according to claim 6, wherein
the at least one time includes a plurality of times,
the plurality of times are counted in calculating maximum amounts of possible consumption, and
the number of sheets as the second value is determined based on the largest of the calculated maximum amounts.

8. The information processing apparatus according to claim 1, wherein
calendar information including business days for a consumer consuming the consumable is acquired, and the business days are counted in determining the second value.

9. The information processing apparatus according to claim 1, wherein
a schedule of an administrator of the consumer consuming the consumable is counted in determining the second value.

10. The information processing apparatus according to claim 1, wherein
the second value is a desired delivery date.

11. The information processing apparatus according to claim 10, wherein
the request unit requests the desired delivery date as the scheduled delivery date.

12. An information processing system comprising:
a transmission unit that transmits remaining amount information indicating a detected remaining amount of a consumable;
a notification unit that notifies of a scheduled date of delivery of the consumable based on the transmitted remaining amount information; and
a request unit that, when the remaining amount of the consumable is detected again upon notification of the scheduled delivery date and when a first value corresponding to the remaining amount detected again differs from a second value predicted, in correspondence with the first value, from information on a history of consuming the consumable, makes a request to change the scheduled delivery date in such a way that the second value approaches or matches the first value.

13. A non-transitory computer readable medium storing a program causing a computer to execute an information processing process comprising:
transmitting remaining amount information indicating a detected remaining amount of a consumable;
receiving a scheduled date of delivery of the consumable notified based on the transmitted remaining amount information; and
when the remaining amount of the consumable is detected again upon reception of the scheduled delivery date and when a first value corresponding to the remaining amount detected again differs from a second value predicted, in correspondence with the first value, from information on a history of consuming the consumable, making a request to change the scheduled delivery date in such a way that the second value approaches or matches the first value.
